(19) United States
(12) Patent Application Publication
(10) Pub. No.: US 2024/0075810 A1
(43) Pub. Date: Mar. 7, 2024

(54) APPARATUS FOR DISTRIBUTING POWER OF AN ELECTRIC VEHICLE AND A METHOD THEREOF

(71) Applicants: HYUNDAI MOTOR COMPANY, Seoul (KR); KIA CORPORATION, Seoul (KR)

(72) Inventors: Dong Hoon Won, Suwon-si (KR); Hyung Seuk Ohn, Seoul (KR); Dong Hoon Jeong, Seongnam-si (KR); Won Seok Jeon, Anyang-si (KR); Ki Sang Kim, Seoul (KR); Byeong Wook Jeon, Seoul (KR); Jung Hwan Bang, Seoul (KR); Hee Yeon Nah, Seoul (KR)

(73) Assignees: HYUNDAI MOTOR COMPANY, Seoul (KR); KIA CORPORATION, Seoul (KR)

(21) Appl. No.: 18/101,815

(22) Filed: Jan. 26, 2023

(30) Foreign Application Priority Data
Sep. 7, 2022 (KR) 10-2022-0113773

(51) Int. Cl. B60K 23/08; B60L 15/20

(52) U.S. Cl. CPC B60K 23/0808; B60L 15/20; B60K 17/356; B60L 2240/12; B60L 2240/463

(57) ABSTRACT

Disclosed are an apparatus for distributing power of an electric vehicle and a method thereof capable of optimally improving the energy consumption efficiency of the electric vehicle by predicting a vehicle speed for a predetermined time using a learned vehicle speed prediction model, determining wheel power based on the vehicle speed, and distributing the wheel power to a front wheel drive motor and a rear wheel drive motor. The apparatus includes a storage that stores a vehicle speed prediction model in which learning is completed, and a controller that predicts a vehicle speed for a preset time using the vehicle speed prediction model, determines wheel power based on the vehicle speed, and distributes the wheel power to a front wheel drive motor and a rear wheel drive motor.

### CROSS-REFERENCE TO RELATED APPLICATION

This application claims the benefit of and priority to Korean Patent Application No. 10-2022-0113773, filed in the Korean Intellectual Property Office on Sep. 7, 2022, the entire contents of which are incorporated herein by reference.

### FIELD

The present disclosure relates to a technology for distributing (or allocating) power to a front wheel drive motor and a rear wheel drive motor such that an electric vehicle has an optimal energy consumption efficiency.

### BACKGROUND

In general, an artificial neural network (ANN), a type of artificial intelligence, is an algorithm for allowing a machine to learn made by simulating a human neural structure. Recently, it has been applied to image recognition, speech recognition, natural language processing and the like with excellent results. An artificial neural network includes an input layer that receives an input, a hidden layer that actually learns, and an output layer that returns the result of an operation. A type of artificial neural network that features plurality of hidden layers is called a deep neural network (DNN), and the DNN may further be classified into smaller categories such as convolutional neural network (CNN) or recurrent neural network (RNN) and the like depending on the structure, purpose, and other factors.

An artificial neural network allows a computer to learn by itself based on data. When trying to solve a problem using an artificial neural network, it is desired to prepare a suitable artificial neural network model and data to be analyzed. Afterwards, the artificial neural network model is trained based on the prepared data. However, before training the model, it is desired to first divide the data into two types—train dataset and—validation dataset. The train dataset is used to train the model, and the validation dataset is used to verify the performance of the model.

There are various reasons for validating an artificial neural network model. For one, during the development process of the ANN, the developer needs to tune the model by modifying the hyper parameters of a model based on the verification result of the model. In addition, the model verification is performed to select a suitable model from various models. The reason why the model verification is necessary is explained in more detail as follows.

The first reason for model verification is to predict accuracy of the model. The purpose of artificial neural networks is to achieve good performance on out-of-sample data not used for training. Therefore, after creating the model, it is desired to check how well the model will perform on out-of-sample data. However, because the model should not be verified using the train dataset, the accuracy of the model should be measured using the validation dataset separated from the train dataset.

The second reason is to increase the performance of the model by tuning the model. For example, by tuning the model using the validation dataset, it is possible to prevent a common problem encountered in artificial intelligence development known as overfitting. Overfitting refers to a problem where the model is over-trained on the train dataset. When the training accuracy is high but the validation accuracy is low, the occurrence of overfitting may be suspected. In addition, the model and its faults may be understood in more detail by the developers through training loss and validation loss. Once the overfitting problem has been detected, it is possible to prevent it by tuning the model using a scheme such as regularization or dropout.

The model on which the learning process and verification process have been completed may be applied to various systems and utilized for various purposes. However, it has not yet seen usage in predicting the speed of an electric vehicle in the process of distributing power to the front wheel drive motor and the rear wheel drive motor of the electric vehicle based on the dynamic programming (DP) algorithm.

According to a conventional technology for distributing power of an electric vehicle, when an event occurs, the torque of a front wheel drive motor and the torque of a rear wheel drive motor are controlled to control the speed of an electric vehicle according to a kind of event. As a result, a conventional technology cannot optimally improve the energy consumption efficiency of an electric vehicle because power is intermittently distributed depending on whether an event occurs. For reference, the fuel efficiency (km/l) of an internal combustion engine vehicle represents the distance (km) that an internal combustion engine vehicle can travel per 1 liter of fuel, and the energy consumption efficiency (km/kWh) of an electric vehicle represents the distance (km) that an electric vehicle can travel per 1 kWh of electricity.

The matters described in this background section are intended to promote an understanding of the background of the disclosure and may include matters that are not already known to those of ordinary skill in the art.

### SUMMARY

The present disclosure has been made to solve the above-mentioned problems occurring in the prior art while advantages achieved by the prior art are maintained intact.

An aspect of the present disclosure provides an apparatus for distributing power of an electric vehicle and a method thereof capable of optimally improving the energy consumption efficiency of the electric vehicle by predicting a vehicle speed for a predetermined time using a learned vehicle speed prediction model, determining wheel power based on the vehicle speed, and distributing the wheel power to a front wheel drive motor and a rear wheel drive motor.

The technical problems to be solved by the present disclosure are not limited to the aforementioned problems, and any other technical problems not mentioned herein will be clearly understood from the following description by those having ordinary skill in the art to which the present disclosure pertains. Also, it may be easily understood that the objects and advantages of the present disclosure may be realized by the units and combinations thereof recited in the claims.

According to an aspect of the present disclosure, an apparatus for distributing power of an electric vehicle includes: a storage that stores a vehicle speed prediction model in which learning is completed, and a controller that predicts a vehicle speed for a preset time using the vehicle speed prediction model. In particular, the controller determines wheel power based on the vehicle speed, and distributes the wheel power to a front wheel drive motor and a rear wheel drive motor.

According to an embodiment, the controller may determine a torque of the front wheel drive motor and a torque of the rear wheel drive motor based on a dynamic programming (DP) algorithm.

According to an embodiment, the controller may predict the vehicle speed for the preset time by inputting information on a road on which the electric vehicle travels and driving information of the electric vehicle to the vehicle speed prediction model.

According to an embodiment, the information on the road may include at least one of slope information of a road located in front of the electric vehicle, information on a traffic light located on the road, a predicted average speed for each section, or a combination thereof.

According to an embodiment, the traffic light information may include at least one of a location of the traffic light and a signal period of the traffic light.

According to an embodiment, the driving information may include at least one of a speed of the electric vehicle, an accelerator pedal position (APS), a brake pedal position (BPS), a driving mode, a driving tendency, a distance from a vehicle in front, or a combination thereof.

According to an embodiment, the controller may determine an acceleration per second based on the vehicle speed for the preset time when a road on which the electric vehicle is scheduled to travel is flat, determine a force on a flat road by multiplying the acceleration by a weight of the electric vehicle, determine a wheel torque by multiplying the force by a tire radius, and determine the wheel power by multiplying the wheel torque by a wheel angular velocity.

According to an embodiment, the controller may determine an acceleration per second based on the vehicle speed for the preset time when a road on which the electric vehicle is scheduled to travel is an uphill road, determine a force on a flat road by multiplying the acceleration by a weight of the electric vehicle, determine an acceleration torque by multiplying the force on the flat road by a tire radius, determine a force on the uphill road, determine a gradient torque by multiplying the force on the uphill road by the tire radius, and determine the wheel power by multiplying a result of adding the acceleration torque and the gradient torque by a wheel angular velocity.

According to an embodiment, the controller may determine an acceleration per second based on the vehicle speed for the preset time when a road on which the electric vehicle is scheduled to travel is a downhill road, determine a force on a flat road by multiplying the acceleration by a weight of the electric vehicle, determine an acceleration torque by multiplying the force on the flat road by a tire radius, determine a force on the downhill road, determine a gradient torque by multiplying the force on the downhill road by the tire radius, and determine the wheel power by multiplying a result of adding the acceleration torque and the gradient torque by a wheel angular velocity.

According to an embodiment, the controller may determine an acceleration per second based on the vehicle speed for the preset time when a road on which the electric vehicle is scheduled to travel is a complex road of an uphill road and a downhill road, determine a force on a flat road by multiplying the acceleration by a weight of the electric vehicle, determine an acceleration torque by multiplying the force on the flat road by a tire radius, determine a force on the uphill road, determine a first gradient torque by multiplying the force on the uphill road by the tire radius, determine a force on the downhill road, determine a second gradient torque by multiplying the force on the downhill road by the tire radius, determine the wheel power by multiplying a result of adding the acceleration torque, the first gradient torque and the second gradient torque by a wheel angular velocity.

According to an aspect of the present disclosure, a method of distributing power of an electric vehicle includes storing, by storage, a vehicle speed prediction model in which learning is completed, predicting, by a controller, a vehicle speed for a preset time using the vehicle speed prediction model, determining, by the controller, wheel power based on the vehicle speed, and distributing, by the controller, the wheel power to a front wheel drive motor and a rear wheel drive motor.

According to an embodiment, the distributing of the wheel power may include determining a torque of the front wheel drive motor and a torque of the rear wheel drive motor based on a dynamic programming (DP) algorithm.

According to an embodiment, the predicting of the vehicle speed may include inputting information on a road on which the electric vehicle travels and driving information of the electric vehicle to the vehicle speed prediction model.

According to an embodiment, the determining of the wheel power may include determining a force on a flat road by multiplying the acceleration by a weight of the electric vehicle when a road on which the electric vehicle is scheduled to travel is flat, determining a force on a flat road by multiplying the acceleration by a weight of the electric vehicle, determining a wheel torque by multiplying the force by a tire radius, and determining the wheel power by multiplying the wheel torque by a wheel angular velocity.

According to an embodiment, the determining of the wheel power may include determining an acceleration per second based on the vehicle speed for the preset time when a road on which the electric vehicle is scheduled to travel is an uphill road, determining a force on a flat road by multiplying the acceleration by a weight of the electric vehicle, determining an acceleration torque by multiplying the force on the flat road by a tire radius and determining a force on the uphill road, determining a gradient torque by multiplying the force on the uphill road by the tire radius, and determining the wheel power by multiplying a result of adding the acceleration torque and the gradient torque by a wheel angular velocity.

According to an embodiment, the determining of the wheel power may include determining an acceleration per second based on the vehicle speed for the preset time when a road on which the electric vehicle is scheduled to travel is a downhill, determining a force on a flat road by multiplying the acceleration by a weight of the electric vehicle, determining an acceleration torque by multiplying the force on the flat road by a tire radius, determining a force on the downhill road, determining a gradient torque by multiplying the force on the downhill road by the tire radius, and determining the wheel power by multiplying a result of adding the acceleration torque and the gradient torque by a wheel angular velocity.

According to an embodiment, the determining of the wheel power may include determining an acceleration per second based on the vehicle speed for the preset time when a road on which the electric vehicle is scheduled to travel is a complex road of an uphill road and a downhill road, determining a force on a flat road by multiplying the acceleration by a weight of the electric vehicle, determining an acceleration torque by multiplying the force on the flat road by a tire radius, determining a force on the uphill road, determining a first gradient torque by multiplying the force on the uphill road by the tire radius, determining a force on the downhill road, determine a second gradient torque by multiplying the force on the downhill road by the tire radius, and determining the wheel power by multiplying a result of adding the acceleration torque, the first gradient torque and the second gradient torque by a wheel angular velocity.

### BRIEF DESCRIPTION OF THE DRAWINGS

The above and other objects, features and advantages of the present disclosure should be more apparent from the following detailed description taken in conjunction with the accompanying drawings:

FIG. 1 is a block diagram illustrating a power distribution system of an electric vehicle to which an embodiment of the present disclosure is applied;

FIG. 2 is a block diagram illustrating a power distribution apparatus for an electric vehicle according to an embodiment of the present disclosure;

FIG. 3A is a view illustrating a first performance analysis of an apparatus for distributing power of an electric vehicle according to a related art;

FIG. 3B is a view illustrating a first performance analysis of an apparatus for distributing power of an electric vehicle according to an embodiment of the present disclosure;

FIG. 4A is a view illustrating a second performance analysis of an apparatus for distributing power of an electric vehicle according to a related art;

FIG. 4B is a view illustrating a second performance analysis of an apparatus for distributing power of an electric vehicle according to an embodiment of the present disclosure;

FIG. 5 is a flowchart illustrating a method of distributing power of an electric vehicle according to an embodiment of the present disclosure; and

FIG. 6 is a block diagram illustrating a computing system for executing a method of distributing power of an electric vehicle according to an embodiment of the present disclosure.

### DETAILED DESCRIPTION

Hereinafter, some embodiments of the present disclosure are described in detail with reference to the drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function is omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It should be further understood that terms, such as those defined in commonly used dictionaries, should be interpreted as having a meaning that is consistent with their meaning in the context of the relevant art and should not be interpreted in an idealized or overly formal sense unless expressly so defined herein.

When a component, device, element, or the like of the present disclosure is described as having a purpose or performing an operation, function, or the like, the component, device, or element should be considered herein as being “configured to” meet that purpose or to perform that operation or function.

In the present disclosure, power distribution of an electric vehicle refers to a process of determining the torque of the front wheel drive motor and the torque of the rear wheel drive motor such that the electric vehicle has a specified wheel power.

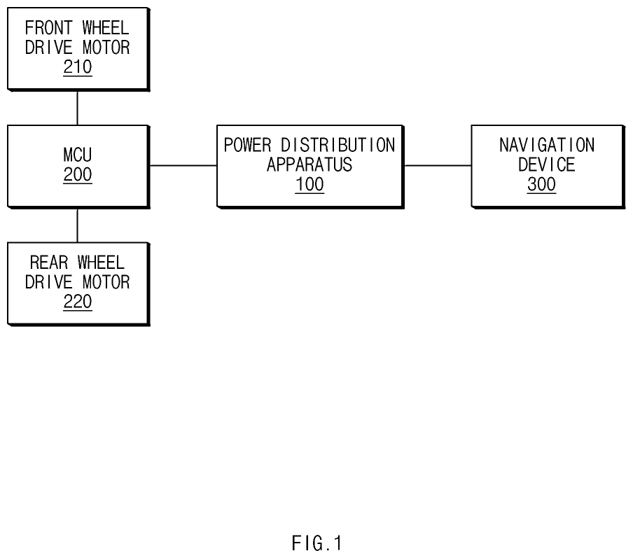

FIG. 1 is a block diagram illustrating a power distribution system of an electric vehicle to which an embodiment of the present disclosure is applied.

As shown in FIG. 1, a power distribution system of an electric vehicle to which an embodiment of the present disclosure is applied may include a power distribution apparatus 100, a motor control unit (MCU) 200, a front wheel drive motor 210, a rear wheel drive motor 220, and a navigation device 300.

Regarding each component, the power distribution apparatus 100 may predict a vehicle speed for a preset time by using a vehicle speed prediction model in which learning is completed, determine the wheel power based on the vehicle speed, and then distribute the wheel power to the front wheel drive motor 210 and the rear wheel drive motor 220 to have an optimal energy consumption efficiency. In this case, when the front of the road on which the electric vehicle travels is flat, the preset time may be, for example, 10 seconds. When the front of the road on which the electric vehicle travels is an uphill road, the preset time may be, for example, 10 seconds or a time expected to pass through the uphill road. When the front of the road on which the electric vehicle travels is a downhill road, the preset time may be, for example, 10 seconds or a time expected to pass through the downhill road. When the front of the road on which the electric vehicle travels is a complex road of uphill and downhill roads, the preset time may be, for example, 10 seconds or a time expected to pass through the complex road of uphill and downhill roads.

The power distribution apparatus 100 may collect a vehicle speed (speed of an electric vehicle), an accelerator pedal position (APS), a brake pedal position (BPS), a driving mode, driving tendency, inter-vehicle distance (distance from a vehicle in front), and the like through a vehicle network, and then predict the vehicle speed for a preset time by inputting the collected information and the information collected from the navigation device 300 to the vehicle speed prediction model. In this case, the driving tendency is information currently provided by most vehicles. For example, the driving tendency close to 100% means that the driver has eco-driving tendency, and the driving tendency close to 0% means that the driver has a reckless driving tendency. In addition, the driving modes may include modes such as a comfort mode which sets up an environment where the driver feels comfortable, a sport mode which enables a dynamic and sporty driving experience, and an eco mode which aims for fuel economy driving, and the like.

The power distribution apparatus 100 may collect the revolutions per minute (RPM) of the front wheel drive motor 210, the RPM of the rear wheel drive motor 220, the efficiency (attribute information) of the front wheel drive motor 210, the efficiency of the rear wheel drive motor 220, the state of charge (SOC) of a battery, and the like through a vehicle network, and may utilize the data collected in the processes of determining wheel power and distributing the wheel power to the front wheel drive motor 210 and the rear wheel drive motor 220. In this case, the vehicle network may include a controller area network (CAN), a CAN flexible data-rate (FD), a local interconnect network (LIN), FlexRay, media oriented systems transport (MOST), an Ethernet, and the like.

The MCU 200, which is a module that performs overall control of the front wheel drive motor 210 and the rear wheel drive motor 220, may control the front wheel drive motor 210 and the rear wheel drive motor 220 based on the torque of the front wheel drive motor 210 and the torque of the rear wheel drive motor 220 determined by the power distribution apparatus 100.

The front wheel drive motor 210, which is a module for driving the right front wheel and the left front wheel of the electric vehicle, may drive the right front wheel and the left front wheel under the control of the MCU 200.

The rear wheel drive motor 220, which is a module for driving the right rear wheel and the left rear wheel of the electric vehicle, may drive the right rear wheel and the left rear wheel under the control of the MCU 200.

The navigation device 300 may provide information on a road on which the electric vehicle travels. In this case, the road information may include slope information of a road located in front of the electric vehicle (that is, the road on which the electric vehicle is scheduled to travel) and information on a traffic light located on the road (i.e., the location of the traffic light, the signal period of the traffic light, and the like) and a predicted average speed for each section. In this case, the slope information may include a flat road, an uphill road, a downhill road, and a complex road of uphill and downhill roads. In addition, the slope information may further include an uphill slope and the length of an uphill section in the case of an uphill road, a downhill slope and the length of a downhill section in the case of an downhill road, and an uphill slope and the length of an uphill section and an downhill slope and the length of an downhill section in the case of a complex road. For example, the section means between the first and second traffic lights adjacent to each other on the road on which the electric vehicle is traveling, and the predicted average speed of passing a section means the average speed predicted when the electric vehicle passes through the section.

The navigation device 300 may collect traffic information of a road through a communication network and predict an average speed of passing through a section of the road based on the traffic information of the road.

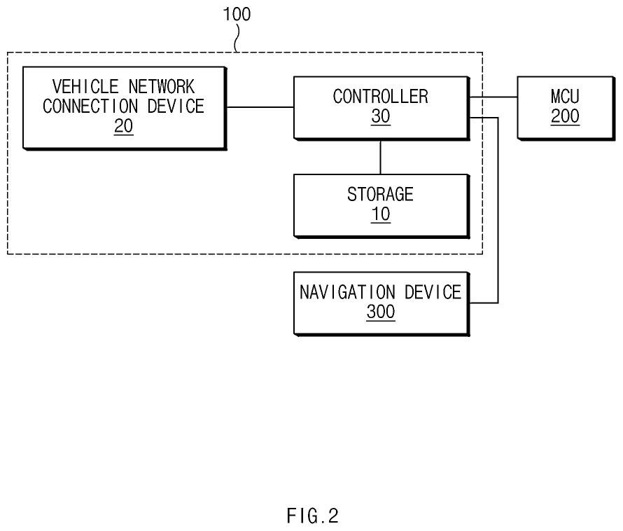

FIG. 2 is a block diagram illustrating a power distribution apparatus for an electric vehicle according to an embodiment of the present disclosure.

As shown in FIG. 2, the power distribution apparatus 100 for an electric vehicle according to an embodiment of the present disclosure may include storage 10, a vehicle network connection device 20, and a controller 30. In this case, depending on a scheme of implementing the power distribution apparatus 100 according to an embodiment of the present disclosure, components may be combined with each other to be implemented as one, or some components may be omitted.

Regarding each component, the storage 10 may store the vehicle speed prediction model (deep learning model) in which learning is completed, the weight of the electric vehicle, and the tire radius of the electric vehicle. In this case, the weight of the electric vehicle may be an empty vehicle weight or a total weight (=empty vehicle weight+maximum loaded weight) as a fixed value.

The storage 10 may store various logic, algorithms and programs required in various processes such as predicting a vehicle speed for a preset time using the vehicle speed prediction model, determining wheel power based on the vehicle speed, and distributing the wheel power to the front wheel drive motor 210 and the rear wheel drive motor 220.

The storage 10 may store a dynamic programming (DP) algorithm required in the process of distributing the wheel power to the front wheel drive motor 210 and the rear wheel drive motor 220 to enable the electric vehicle to have an optimal energy consumption efficiency. The DP algorithm may determine the torque of the front wheel drive motor 210 and the torque of the rear wheel drive motor 220 corresponding to the wheel power such that the electric vehicle has an optimal energy consumption efficiency.

The storage 10 may include at least one type of a storage device such as a flash drive, a hard disk, a micro storage, a card storage (e.g., a secure digital (SD) card or an extreme digital (XD) card), a random access memory (RAM), a static RAM, a read-only memory (ROM), a programmable ROM (PROM), an electrically erasable PROM (EEPROM), a magnetic memory (MRAM), a magnetic disk, or an optical disk type memory.

The vehicle network connection device 20 is a module that provides a connection interface with a vehicle network. In this case, the vehicle network transmits and receives various data from various sensors and systems provided in an electric vehicle.

The controller 30 may perform overall control such that each component performs its function. The controller 30 may be implemented as a hardware, software, or a combination of hardware and software. In one embodiment, the controller 30 may be implemented as a microprocessor, but is not limited thereto.

Specifically, the controller 30 may be implemented with a vehicle control unit (VCU) and may perform various control in the processes of predicting a vehicle speed for a preset time using the vehicle speed prediction model, determining wheel power based on the vehicle speed and distributing the wheel power to the front wheel drive motor 210 and the rear wheel drive motor 220. Hereinafter, the operation of the controller 30 is described in detail.

The controller 30 may provide information on a road on which the electric vehicle travels through the navigation device 300. In this case, the road information may include slope information of a road located in front of the electric vehicle (that is, the road on which the electric vehicle is scheduled to travel) and information on a traffic light located on the road (i.e., the location of the traffic light, the signal period of the traffic light, and the like) and a predicted average speed for each section. In this case, the slope information may include information about whether the road is a flat road, an uphill road, a downhill road, or a complex road of uphill and downhill roads. In addition, the slope information may further include an uphill slope and the length of an uphill section in the case of an uphill road, an downhill slope and the length of an downhill section in the case of an downhill road, and an uphill slope and the length of an uphill section and an downhill slope and the length of an downhill section in the case of a complex road. For example, the section means between the first and second traffic lights adjacent to each other on the road on which the electric vehicle is traveling, and the predicted average speed of passing a section means the average speed predicted when the electric vehicle passes through the section.

The controller 30 may collect a vehicle speed (speed of an electric vehicle), an accelerator pedal position (APS), a brake pedal position (BPS), a driving mode, driving tendency, inter-vehicle distance (distance from a vehicle in front), and the like through a vehicle network.

The controller 30 may input the road information such as slope information, traffic light information, and a predicted average speed for each section and the driving information such as a vehicle speed, an APS, a BPS, a driving mode, driving tendency, and an inter-vehicle distance in order to predict the vehicle speed for a preset time.

Hereinafter, in the case where the slope information corresponds to a flat road, an uphill road, a downhill road, and a complex road of uphill and downhill roads, respectively, a process of determining wheel power is described below.

In the case of a flat road, the controller 30 may determine an acceleration per second based on the vehicle speed for a preset time, determine a force on a flat road by multiplying the acceleration by the weight of the electric vehicle, determine a wheel torque by multiplying the force by a tire radius, and determine the wheel power by multiplying the wheel torque by a wheel angular velocity. Also, the weight of the electric vehicle may be stored in the storage 10 and the controller 30 may collect the wheel angular velocity through the vehicle network.

In the case of an uphill road, the controller 30 may determine an acceleration per second based on the vehicle speed for a preset time, determine a force on a flat road by multiplying the acceleration by the weight of the electric vehicle, and then determine the acceleration torque by multiplying the force on the flat road by a tire radius. In addition, the controller 30 may determine the force (tilt resistance) on the uphill road by using following Equation 1 and may determine the gradient torque (uphill torque) by multiplying the force on the uphill road by the tire radius. Thereafter, the controller 30 may determine the wheel power by multiplying the result of adding the acceleration torque and the gradient torque by the wheel angular velocity.

F=m×g×sin α [Equation 1]
where, F represents a tilt resistance, m represents the weight of an electric vehicle, and a represents an uphill inclination angle.

In the case of a downhill road, the controller 30 may determine an acceleration per second based on the vehicle speed for a preset time, determine a force on a flat road by multiplying the acceleration by the weight of the electric vehicle, and then determine an acceleration torque by multiplying the force on the flat road by a tire radius. In addition, the controller 30 may determine the force (tilt resistance) on the downhill road by using following Equation 2 and may also determine the gradient torque (downhill torque) by multiplying the force on the downhill road by the tire radius. Thereafter, the controller 30 may determine the wheel power by multiplying the result of adding the acceleration torque and the gradient torque by the wheel angular velocity.

F=m×g×sin β [Equation 2]
where, F represents the tilt resistance, m represents the weight of the electric vehicle, and β represents the downhill inclination angle.

In the case of a complex road of uphill and downhill roads, the controller 30 may determine an acceleration per second based on the vehicle speed for a preset time, determine a force on a flat road by multiplying the acceleration by a weight of the electric vehicle, and then determine an acceleration torque by multiplying the force on the flat road by a tire radius. Then, the controller 30 may determine the force on the uphill road by using Equation 1 and may also determine the first gradient torque (uphill torque) by multiplying the force on the uphill road by the tire radius. In addition, the controller 30 may determine the force (tilt resistance) on the downhill road by using Equation 2 and may determine the second gradient torque (downhill torque) by multiplying the force on the downhill road by the tire radius. Thereafter, the controller 30 may determine the wheel power by multiplying the result of adding the acceleration torque, the first gradient torque, and the second gradient torque by the wheel angular velocity.

Meanwhile, when the wheel power determined on an uphill road exceeds a first reference value, when the wheel power determined on a downhill road exceeds a second reference value, or when the wheel power determined on a complex road of uphill and downhill roads exceeds a third reference value, the controller may determine the torque of the front wheel drive motor 210 and the torque of the rear wheel drive motor 220 based on the DP algorithm. In other cases, the controller 30 may determine the torque of the front wheel drive motor 210 and the torque of the rear wheel drive motor 220 based on a map (hereinafter, referred to as a wheel power map) in which the minimum power required for driving is recorded.

The controller 30 may collect the RPM of the front wheel drive motor 210, the RPM of the rear wheel drive motor 220, the efficiency (attribute information) of the front wheel drive motor 210, the efficiency of the rear wheel drive motor 220, the SOC of the battery, and the like through the vehicle network.

The controller 30 may determine the torque of the front wheel drive motor 210 and the torque of the rear wheel drive motor 220 corresponding to the wheel power such that the electric vehicle has an optimal energy consumption efficiency, based on the RPM of the front wheel drive motor 210, the RPM of the rear wheel drive motor 220, the efficiency of the front wheel drive motor 210, the efficiency of the rear wheel drive motor 220, and the SOC of the battery collected. In this case, the controller 30 may determine the torque of the front wheel drive motor 210 and the torque of the rear wheel drive motor 220 by using the DP algorithm.

The controller 30 may transmit, to the MCU 200, the torque of the front wheel drive motor 210 and the torque of the rear wheel drive motor 220.

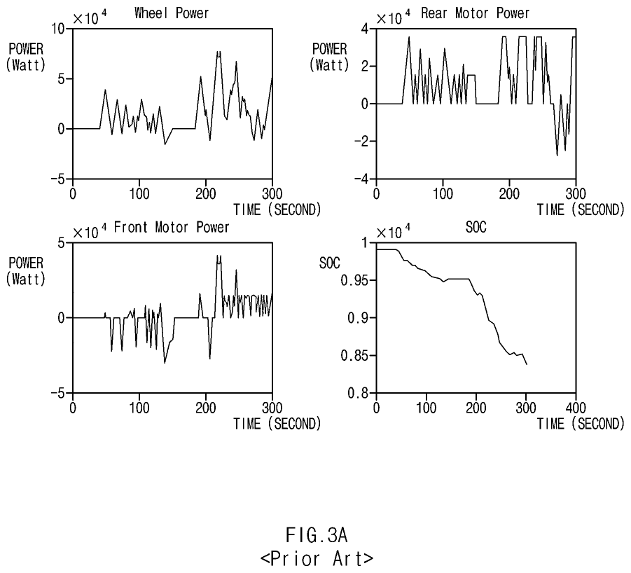

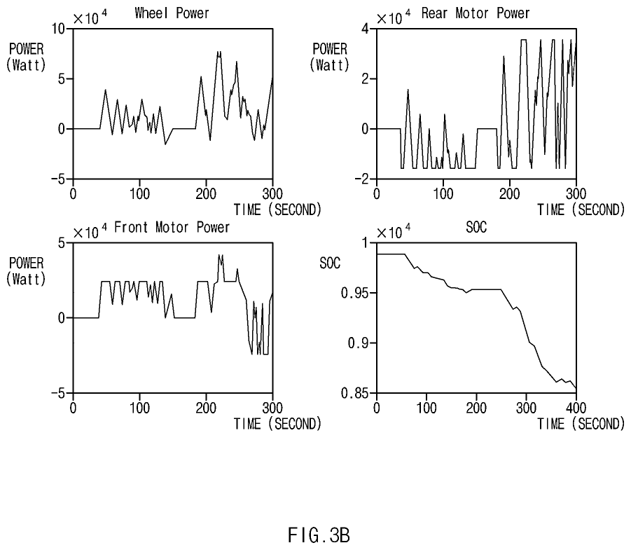

FIG. 3A is a view illustrating a first performance analysis of an apparatus for distributing power of an electric vehicle according to a related art. FIG. 3A illustrates the SOC of a battery on a flat road.

FIG. 3B is a view illustrating a first performance analysis of an apparatus for distributing power of an electric vehicle according to an embodiment of the present disclosure. FIG. 3B illustrates an SOC of a battery on a flat road.

It may be understood that the performance of an apparatus for distributing power of an electric vehicle according to the embodiment of the present disclosure shown in FIG. 3B is better than that of an apparatus for distributing power of an electric vehicle according to the related art shown in FIG. 3A. That is, it may be understood through SOC that the scheme according to the present disclosure improves energy consumption efficiency by about 1.2% compared to that of the related art.

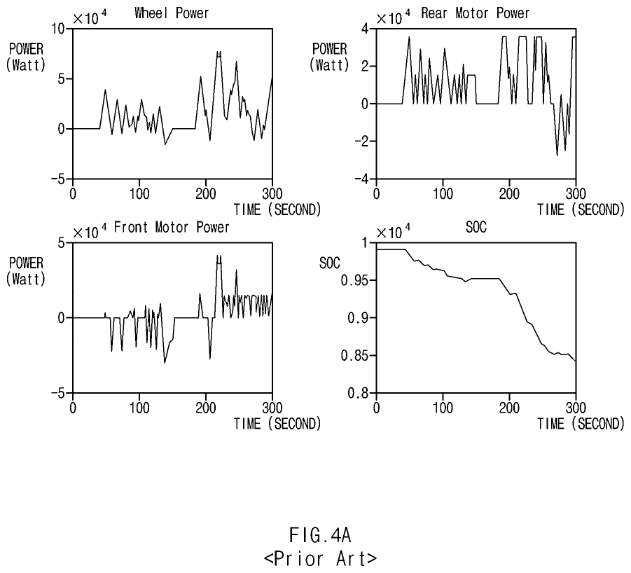

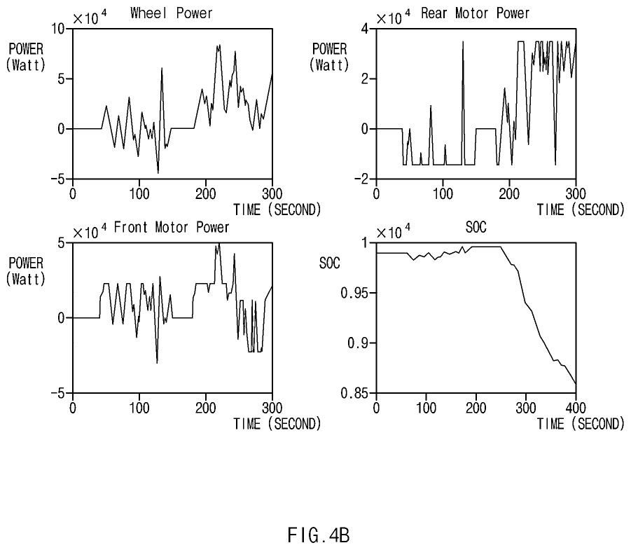

FIG. 4A is a view illustrating a second performance analysis of an apparatus for distributing power of an electric vehicle according to a related art. FIG. 4A illustrates the SOC of a battery on a slope road.

FIG. 4B is a view illustrating a second performance analysis of an apparatus for distributing power of an electric vehicle according to an embodiment of the present disclosure. FIG. 4B illustrates an SOC of a battery on a slope road.

It may be understood that the performance of an apparatus for distributing power of an electric vehicle according to the embodiment of the present disclosure shown in FIG. 4B is better than that of an apparatus for distributing power of an electric vehicle according to the related art shown in FIG. 4A. That is, it may be understood through SOC that the scheme according to the present disclosure improves energy consumption efficiency by about 0.5% compared to that of the related art.

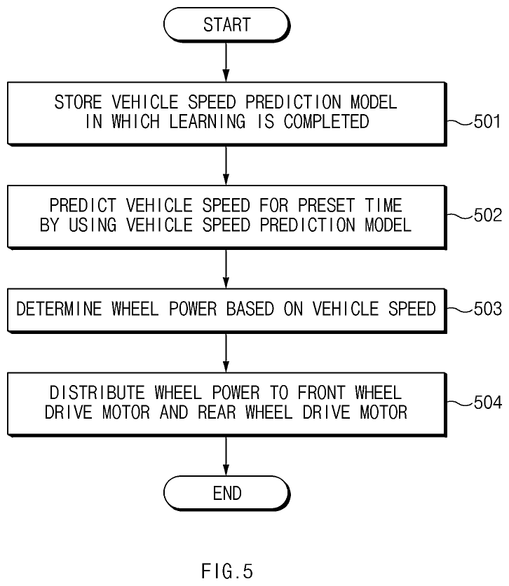

FIG. 5 is a flowchart illustrating a method of distributing power of an electric vehicle according to an embodiment of the present disclosure.

First, in 501, the storage 10 stores a vehicle speed prediction model in which learning is completed.

Then, in 502, the controller 30 predicts a vehicle speed for a preset time by using the vehicle speed prediction model.

Then, in 503, the controller 30 determines wheel power based on the vehicle speed.

Then, in 504, the controller 30 distributes the wheel power to the front wheel drive motor and the rear wheel drive motor.

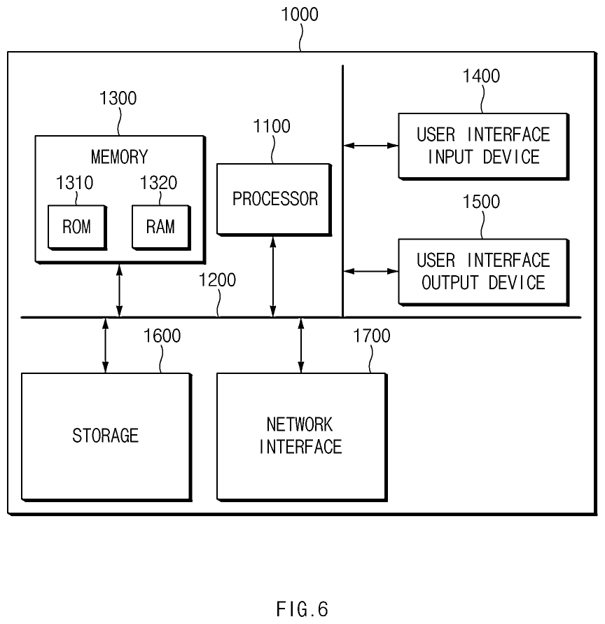

FIG. 6 is a block diagram illustrating a computing system for executing a method of distributing power of an electric vehicle according to an embodiment of the present disclosure.

Referring to FIG. 6, a method of distributing power of an electric vehicle according to an embodiment of the present disclosure described above may be implemented through a computing system. A computing system 1000 may include at least one processor 1100, a memory 1300, a user interface input device 1400, a user interface output device 1500, storage 1600, and a network interface 1700 connected through a system bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the processes of the method or algorithm described in relation to the embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

As described above, the apparatus for distributing power of an electric vehicle and the method thereof according to the embodiments of the present disclosure may optimally improve the energy consumption efficiency of the electric vehicle by predicting a vehicle speed for a predetermined time using a learned vehicle speed prediction model, determining wheel power based on the vehicle speed, and then distributing the appropriate amount of power to a front wheel drive motor and a rear wheel drive motor.

Although embodiments of the present disclosure have been described for illustrative purposes, those having ordinary skill in the art should appreciate that various modifications, additions and substitutions are possible, without departing from the scope and spirit of the disclosure.

Therefore, the embodiments disclosed in the present disclosure are provided for the sake of descriptions, not limiting the technical concepts of the present disclosure, and it should be understood that such embodiments are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. An apparatus for distributing power of an electric vehicle, the apparatus comprising:
a storage configured to store a vehicle speed prediction model in which learning is completed; and
a controller configured to:
predict a vehicle speed for a preset time using the vehicle speed prediction model,
determine wheel power based on the vehicle speed, and
distribute the wheel power to a front wheel drive motor and a rear wheel drive motor.

2. The apparatus of claim 1, wherein the controller is configured to determine a torque of the front wheel drive motor and a torque of the rear wheel drive motor based on a dynamic programming (DP) algorithm.

3. The apparatus of claim 1, wherein the controller is configured to predict the vehicle speed for the preset time by inputting information on a road on which the electric vehicle travels and driving information of the electric vehicle to the vehicle speed prediction model.

4. The apparatus of claim 3, wherein the information on the road includes at least one of slope information of a road located in front of the electric vehicle, information on a traffic light located on the road, a predicted average speed for each section, or a combination thereof.

5. The apparatus of claim 4, wherein the traffic light information includes at least one of a location of the traffic light and a signal period of the traffic light.

6. The apparatus of claim 3, wherein the driving information includes at least one of a speed of the electric vehicle, an accelerator pedal position (APS), a brake pedal position (BPS), a driving mode, a driving tendency, a distance from a vehicle in front, or a combination thereof.

7. The apparatus of claim 1, wherein the controller is configured to:
determine an acceleration per second based on the vehicle speed for the preset time when a road on which the electric vehicle is scheduled to travel is flat,
determine a force on a flat road by multiplying the acceleration by a weight of the electric vehicle,
determine a wheel torque by multiplying the force by a tire radius, and
determine the wheel power by multiplying the wheel torque by a wheel angular velocity.

8. The apparatus of claim 1, wherein the controller is configured to:
determine an acceleration per second based on the vehicle speed for the preset time when a road on which the electric vehicle is scheduled to travel is an uphill road,
determine a force on a flat road by multiplying the acceleration by a weight of the electric vehicle,
determine an acceleration torque by multiplying the force on the flat road by a tire radius,
determine a force on the uphill road,
determine a gradient torque by multiplying the force on the uphill road by the tire radius, and
determine the wheel power by multiplying a result of adding the acceleration torque and the gradient torque by a wheel angular velocity.

9. The apparatus of claim 1, wherein the controller is configured to:
determine an acceleration per second based on the vehicle speed for the preset time when a road on which the electric vehicle is scheduled to travel is a downhill road,
determine a force on a flat road by multiplying the acceleration by a weight of the electric vehicle,
determine an acceleration torque by multiplying the force on the flat road by a tire radius,
determine a force on the downhill road,
determine a gradient torque by multiplying the force on the downhill road by the tire radius, and
determine the wheel power by multiplying a result of adding the acceleration torque and the gradient torque by a wheel angular velocity.

10. The apparatus of claim 1, wherein the controller is configured to:
determine an acceleration per second based on the vehicle speed for the preset time when a road on which the electric vehicle is scheduled to travel is a complex road of an uphill road and a downhill road,
determine a force on a flat road by multiplying the acceleration by a weight of the electric vehicle,
determine an acceleration torque by multiplying the force on the flat road by a tire radius,
determine a force on the uphill road, determine a first gradient torque by multiplying the force on the uphill road by the tire radius,
determine a force on the downhill road,
determine a second gradient torque by multiplying the force on the downhill road by the tire radius, and
determine the wheel power by multiplying a result of adding the acceleration torque, the first gradient torque and the second gradient torque by a wheel angular velocity.

11. A method of distributing power of an electric vehicle, the method comprising:
storing, by a storage, a vehicle speed prediction model in which learning is completed;
predicting, by a controller, a vehicle speed for a preset time using the vehicle speed prediction model;
determining, by the controller, wheel power based on the vehicle speed; and
distributing, by the controller, the wheel power to a front wheel drive motor and a rear wheel drive motor.

12. The method of claim 11, wherein the distributing of the wheel power includes:
determining a torque of the front wheel drive motor and a torque of the rear wheel drive motor based on a dynamic programming (DP) algorithm.

13. The method of claim 11, wherein the predicting of the vehicle speed includes:
inputting information on a road on which the electric vehicle travels and driving information of the electric vehicle to the vehicle speed prediction model.

14. The method of claim 13, wherein the information on the road includes at least one of slope information of a road located in front of the electric vehicle, information on a traffic light located on the road, a predicted average speed for each section, or a combination thereof.

15. The method of claim 14, wherein the traffic light information includes at least one of a location of the traffic light or a signal period of the traffic light.

16. The method of claim 13, wherein the driving information includes at least one of a speed of the electric vehicle, an accelerator pedal position (APS), a brake pedal position (BPS), a driving mode, a driving tendency, a distance from a vehicle in front, or a combination thereof.

17. The method of claim 11, wherein the determining of the wheel power includes:
determining a force on a flat road by multiplying an acceleration by a weight of the electric vehicle when a road on which the electric vehicle is scheduled to travel is flat;
determining a force on a flat road by multiplying the acceleration by a weight of the electric vehicle;
determining a wheel torque by multiplying the force by a tire radius; and
determining the wheel power by multiplying the wheel torque by a wheel angular velocity.

18. The method of claim 11, wherein the determining of the wheel power includes:
determining an acceleration per second based on the vehicle speed for the preset time when a road on which the electric vehicle is scheduled to travel is an uphill road;
determining a force on a flat road by multiplying the acceleration by a weight of the electric vehicle;
determining an acceleration torque by multiplying the force on the flat road by a tire radius and determining a force on the uphill road;
determining a gradient torque by multiplying the force on the uphill road by the tire radius; and
determining the wheel power by multiplying a result of adding the acceleration torque and the gradient torque by a wheel angular velocity.

19. The method of claim 11, wherein the determining of the wheel power includes:
determining an acceleration per second based on the vehicle speed for the preset time when a road on which the electric vehicle is scheduled to travel is a downhill;
determining a force on a flat road by multiplying the acceleration by a weight of the electric vehicle;
determining an acceleration torque by multiplying the force on the flat road by a tire radius;
determining a force on the downhill road;
determining a gradient torque by multiplying the force on the downhill road by the tire radius; and
determining the wheel power by multiplying a result of adding the acceleration torque and the gradient torque by a wheel angular velocity.

20. The method of claim 11, wherein the determining of the wheel power includes:
determining an acceleration per second based on the vehicle speed for the preset time when a road on which the electric vehicle is scheduled to travel is a complex road of an uphill road and a downhill road;
determining a force on a flat road by multiplying the acceleration by a weight of the electric vehicle;
determining an acceleration torque by multiplying the force on the flat road by a tire radius;
determining a force on the uphill road;
determining a first gradient torque by multiplying the force on the uphill road by the tire radius;
determining a force on the downhill road;
determine a second gradient torque by multiplying the force on the downhill road by the tire radius; and
determining the wheel power by multiplying a result of adding the acceleration torque, the first gradient torque and the second gradient torque by a wheel angular velocity.
